(19) United States
(12) Patent Application Publication
(10) Pub. No.: US 2025/0074305 A1
(43) Pub. Date: Mar. 6, 2025

(54) MESSAGE PANEL FOR VEHICLES

(71) Applicant: Steve Bernard McTaw, Austell, GA (US)

(72) Inventor: Steve Bernard McTaw, Austell, GA (US)

(21) Appl. No.: 18/819,565

(22) Filed: Aug. 29, 2024

Related U.S. Application Data
(60) Provisional application No. 63/579,439, filed on Aug. 29, 2023.

(51) Int. Cl. B60Q 7/00; G09F 19/12; G09F 21/04

(52) U.S. Cl. CPC B60Q 7/00; G09F 19/12; G09F 21/0485

(57) ABSTRACT

A vehicle messaging device includes a support base configured to be positioned on an exterior surface of a vehicle window. The vehicle messaging device includes a support pole coupled to a first side of the support base and configured to extend outward from the exterior surface of the vehicle window. Further, the vehicle messaging device includes a message panel coupled along the support pole and configured to display a message in a message area. Additionally, the vehicle messaging device includes a flexible handle coupled to at least a second side of the support base and including at least one attachment device. The flexible handle is configured to travel over a top surface of the vehicle window, and the at least one attachment device is configured to couple to an interior surface of the vehicle window.

### CROSS-REFERENCE TO RELATED APPLICATIONS

This application claims the benefit of priority of U.S. provisional application No. 63/579,439, filed Aug. 29, 2023, titled “Roadside Emergency Information Device Vehicle Messaging Panel System and Method” the entire contents of which are herein incorporated by reference.

### FIELD

The present disclosure relates to safety devices and, more particularly, to vehicle safety devices.

### BACKGROUND

Vehicles often run into maintenance issues or other mechanical issues on the road. Pulling over on the roadside can be a dangerous maneuver, and it can be difficult to communicate the details of the situation to other passing drivers. Existing solutions to this—such as vehicle flashers or the use of road cones—do not clearly communicate information to passersby and may require the driver to step out of the vehicle to deploy, leading to a safety risk for the driver.

As can be seen, there is a need for systems and methods that address the above drawbacks.

### SUMMARY

In one aspect of the present disclosure, a vehicle messaging device includes a support base configured to be positioned on an exterior surface of a vehicle window. The vehicle messaging device includes a support pole coupled to a first side of the support base and configured to extend outward from the exterior surface of the vehicle window. Further, the vehicle messaging device includes a message panel coupled along the support pole and configured to display a message in a message area. Additionally, the vehicle messaging device includes a flexible handle coupled to at least a second side of the support base and including at least one attachment device. The flexible handle is configured to travel over a top surface of the vehicle window, and the at least one attachment device is configured to couple to an interior surface of the vehicle window.

### BRIEF DESCRIPTION OF THE DRAWINGS

FIG. 1 is a perspective view of a vehicle messaging device in use, according to aspects of the present disclosure;

FIG. 2 is a front view of the vehicle messaging device, according to aspects of the present disclosure;

FIG. 3 is a detailed front view of the vehicle messaging device, according to aspects of the present disclosure;

FIG. 4 is a side view of the vehicle messaging device, according to aspects of the present disclosure; and

FIG. 5 is a rear view of the vehicle messaging device, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, there exists a need for a safety device capable of catching the attention of passersby and communicating information clearly to passersby while retaining the safety of the user. Broadly, an embodiment of the present disclosure provides a vehicle messaging device that solves the above problems by providing a safe, quick, and clear mechanism for alerting passersby to any issues with a vehicle. The vehicle messaging device includes a vehicle messaging panel system adapted to deploy out of the window of a vehicle. The vehicle messaging device can include a strobe light, strobe light attachment point, a panel support pole, a message panel, a panel o-ring stop, a panel pole retaining cord, a message panel pole support base, a panel pole retaining cord hook, a web handle with suction cups, and a vehicle window protector.

In embodiments, to use the vehicle messaging device, a driver may select a message panel/support pole combination from a selection of pre-written message panels installed on pre-measured poles. The user may place the message panel support pole into the message panel pole support base, then attach the panel pole retaining cord to the retaining cord hook, the provided strobe light may then be placed on the selected message panel in the strobe light attaching area and activated. Next, the user may partially roll down the vehicle window and place the support base and attached panel outside the window, while holding the web handle with the suction cups inside the window. Once the message panel is deployed outside, the user may pull the web handle until the support base is near the top of the window glass, then raise the window to reinforce the base support. The suction cups on the web handle may then be attached to the window to keep the system in place. Once in place, the activated strobe light draws the attention of other passersby to the selected message.

The compact design of the vehicle messaging device allows the system to be easily stored within a vehicle, such as by using a hook-and-loop fastener to attach the system to a floor mat or by storing the system beneath a seat. The vehicle messaging device thus provides a safe system for displaying a succinct message to passersby to update any other drivers on the vehicle status.

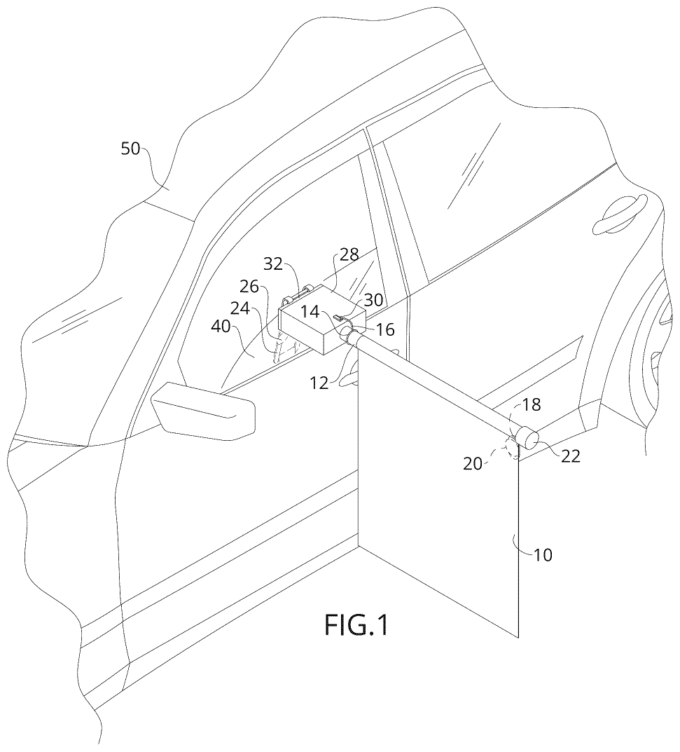

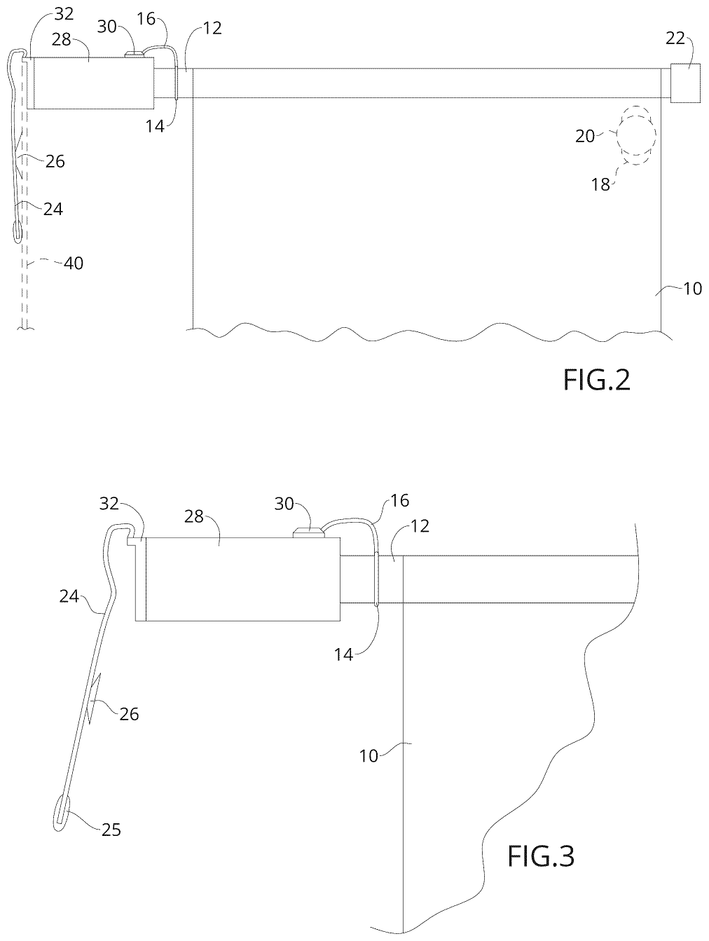

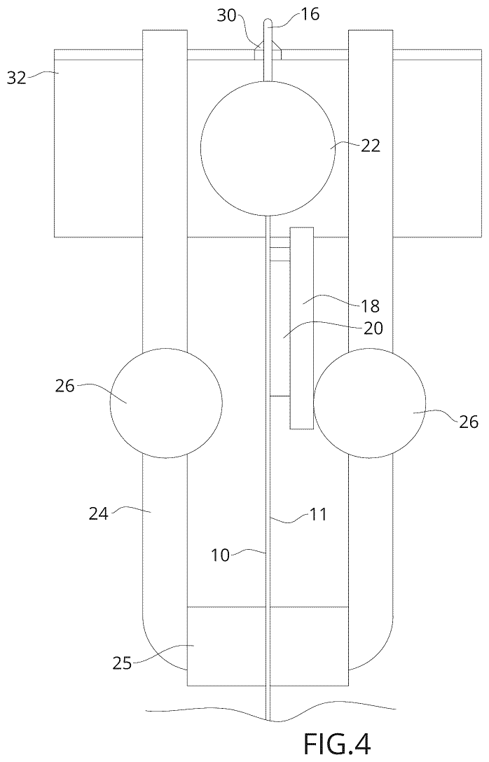

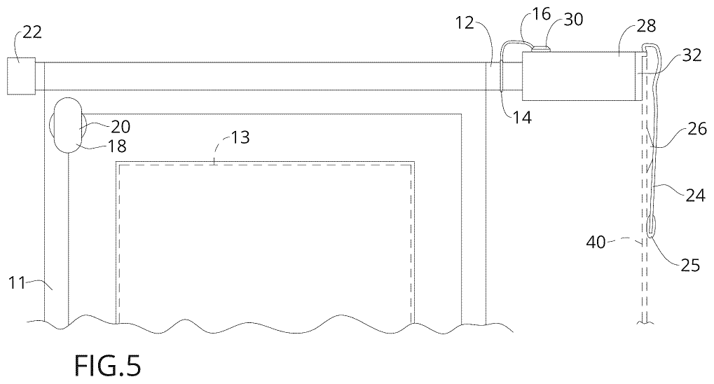

Referring now to FIGS. 1-5, FIGS. 1-5 illustrate a vehicle messaging device, according to aspects of the present disclosure. While FIGS. 1-5 illustrate examples of components of the vehicle messaging device, additional components can be added and existing components can be removed and/or modified.

As illustrated in FIG. 1-5, the vehicle messaging device provides a safe, quick, and clear mechanism for alerting passersby to any issues with a vehicle, e.g., vehicle 50. The vehicle messaging device is adapted to deploy out of the window of a vehicle. The vehicle messaging device includes a strobe light 18, strobe light attachment point 20, a support pole 12, a message panel 10, a panel o-ring stop 14, a panel pole retaining cord 16, a support base 28, a retaining cord hook 30, a web handle 24 with suction cups 26, and a vehicle window protector 32.

In embodiments, the message panel 10 is coupled to and hangs from the support pole 12. The message panel 10 includes a front side 11 and a message area 13 on the front side 11. The message panel 10 can be constructed of a lightweight material such as plastic, canvas, or paper that is adapted to receive writing in the form of ink, printing, or other similar means of adding text to a material. In embodiments, the message area 13 can include a pre-written message that is intended to give passerby information on the status of the vehicle. For example, the message might read “CAUTION, VEHICLE STALLED”, “NEED HELP”, or “I'M OKAY, DON'T STOP”.

In some embodiments, the message panel 10 can be constructed to be integral to the support pole 12, and multiple message panels 10 and support poles 12 can be provided. In some embodiments, the message panel 10 can be detachably attachable to the support pole 12. In some embodiments, the message area 13 can be constructed of a material that can be written on and erased. In some embodiments, the message area 13 can be removable, for example, attached with hook and loop, from the front side 11 and can be replaced with a new message area 12 with a different message.

The message panel 10 is ideally adapted with a receiving hole at a first end of the message panel 10, the receiving hole being of a shape and size to receive the support pole 12. In some embodiments, the message panel 10 can be weighted to be able to withstand windy conditions without fluttering or crimping, so it can remain flat and readable even in inclement weather. In some embodiments, the message panel 10 can include a visible color designed to catch the eye, such as fluorescent yellow.

The support pole 12 is removably coupled to the support base 28 at a first side of the support base 28. The support pole 12 can be an elongated member, such as a rod, having a first end and a second end. At the first end of support pole 12, the strobe attachment point 20 can be positioned. At the second end of the support pole 12, the panel pole retaining cord 16 can be positioned. The support pole 12 can adapted to slot through the receiving hole on the message panel 10 to hold the message panel 10. The o-ring 14 is adapted to prevent the message panel 10 from slipping off of the support pole 12, and to provide a point of attachment for the panel pole retaining cord 16. The o-ring 14 can be sized to fit perimetrically around the support pole 12. The support pole 12 can also include a cap 22 coupled to an end of the support pole 12. The cap 22 can operate to prevent the message panel from slipping off the support pole 12.

The strobe light 18 can include comprise any light capable of producing a strobing or blinking effect as is well-known in the art. The strobe light 18 can include an light emitting diode (LED), halogen, or similar bulb or bulbs that are well-known in the art. The strobe light 18 can include an attachment mechanism, such as a loop or fastener, that is adapted to attach the strobe light 18 to the strobe light attachment point 20. In some embodiments, the strobe light 18 can be rechargeable or battery-operated. In some embodiments, the strobe light attachment point 20 can include a hole or fastener that is positioned at one end of the support pole 12. The strobe light attachment point 20 is adapted to receive and retain the strobe light 18. In some embodiments, the strobe light attachment point 20 can be positioned on all message panels in the upper left section of the message panel. In the ideal embodiment, the strobe light attachment point 20 can include a hole adapted to receive the strobe light attachment mechanism.

The support base 28 can be constructed as a strong, durable, lightweight padded device that is adapted to fit over the window 40 of the vehicle 50 and provide an attachment point for the support pole 12 and message panel 10. The support base 28 can include a support pole attachment point, a plurality of fasteners, and the vehicle window protection 32. The support pole attachment point can be a hole that is configured to receive the support pole 12, allowing the support pole to be detachably attached to the support base 28. The plurality of fasteners may be adapted to secure the web handle 24 to the support base 28. In some embodiments, the vehicle window protection 32 is attached to one or more sides of the support base 28, e.g., the sides that abut the window 40 of the vehicle 50, thereby protecting the window 40 from scratching or damaging when the vehicle 50 is in use. The vehicle window protection 32 can include a padded material, such as Styrofoam, fabric, or a similar soft, padded material.

The retaining cord 16 can operate as a safety mechanism for the support pole 12 to ensure the support pole 12 stays inserted in the support base 28. The retaining cord 16 can adapted to encompass or fasten to the support base 28 to ensure the support pole does not come loose during use of the vehicle messaging system. The cord hook 30 can include a hook adapted to latch on to any viable attachment point. The cord hook 30 can be fastened or detachably attached to the retaining cord 16, and can be configured to help latch the vehicle messaging device in place.

The web handle 24 can coupled to a side of the support base 28. The web handle 24 can be constructed of a flexible material and operates to couple the support base 28 to the window 40. The web handle 24 can include one or more suction cups 26, for example, a first suction cup and a second suction cup. The web handle 24 can include a first end and a second end. In some embodiments, the web handle 24 is fastened to the support base at both the first end and the second end.

The one or more suction cups 26 can be fastened to the web handle 24. In embodiments, the web handle 24 can be formed as a U-shaped loop, with a handle grip 25 formed at the curve of the loop. In some embodiments, the first suction cup 26 can be positioned a first leg of the U-shaped loop of the web handle 24, and the second suction cup 26 cam be positioned at the second leg of the U-shaped loop of the web handle 24.

As illustrated in FIG. 1, the vehicle messaging device is configured to be used with a vehicle 50, e.g., coupled to a window 40 of the vehicle. To use the vehicle messaging device, the driver of the vehicle 50 can first pull the vehicle off the road into a safe location, if possible, and turn on the hazard warning lights of the vehicle 50. Next, the driver can select a message panel 10 that has a message they want to display to other drivers. The driver can then place the strobe light 18 into the strobe light attachment point 20 and turn the strobe light 18 on. At this point, the driver can then partially roll down the vehicle window 40, for example, on the driver's side. With one hand, the driver can take the support base 28, and place these support base 28, support pole 12, and message panel 10 outside the window 40, while holding the web handle 24 in the other hand. Once the support base 28, support pole 12, and message panel 10 are outside the vehicle 50, the driver can release the grip on the support base 28, while maintaining a hold on the web handle 24. Next, the driver can let the support base 28 rest on an exterior surface of the window 40, then pull the web handle 24 until the support base 28 is near a top of the window, e.g., about three inches from the top of the window glass, then raise the vehicle window 40. Once the window 40 is raised (thereby trapping the web handle 24 between the window 40 and the window/door frame, the driver can attach the web handle 24 to the interior surface of the vehicle window 40 by pressing the suction cups 26 of the web handle against 24 the vehicle window 40. The driver can then release their hold on the web handle 24, and the vehicle messaging device can remain in place on the window 40, display the message panel 10 to any passerby.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A vehicle messaging device, comprising:
a support base configured to be positioned on an exterior surface of a vehicle window;
a support pole coupled to a first side of the support base and configured to extend outward from the exterior surface of the vehicle window;
a message panel coupled along the support pole and configured to display a message in a message area; and
a flexible handle coupled to at least a second side of the support base and comprising at least one attachment device, wherein the flexible handle is configured to travel over a top surface of the vehicle window, and the at least one attachment device is configured to couple to an interior surface of the vehicle window.

2. The vehicle messaging device of claim 1, further comprising:
a strobe light coupled to at least one of the message panel or the support pole.

3. The vehicle messaging device of claim 1, further comprising:
window protection device coupled between the support base and the exterior surface of the vehicle window, wherein the window protection device protects the vehicle window from damage by the support base.

4. The vehicle messaging device of claim 1, further comprising:
an attachment cord coupled to the support base and the support pole, wherein the support pole is removably coupled to the support base, and the attachment cord secures the support pole to the support base.

5. The vehicle messaging device of claim 1, wherein the message panel is removably coupled to the support pole.

6. The vehicle messaging device of claim 1, wherein the message area is removable from the message panel.

7. The vehicle messaging device of claim 1, wherein the message area comprises an erasable surface for writing a message.

8. The vehicle messaging device of claim 1, wherein the at least one attachment device comprises a suction cup.

9. A method for displaying a message on a vehicle, comprising:
attaching a message panel to a support rod, wherein the message panel is configured to display a message in a message area;
attaching the support rod to a support base at a first side of the support base;
causing a vehicle window to at least partially open;
positioning the support base on an exterior surface of a vehicle window, wherein the support pole extends outward from the exterior surface of the vehicle window;
positing a flexible handle that is coupled to at least a second side of the support base over a top surface of the vehicle window;
causing the vehicle window to close, wherein a portion of the flexible handle is closed between the top surface of the vehicle window and a portion of the vehicle door; and
coupling the flexible handle to an interior surface of the vehicle window.

10. The method of claim 9, wherein the flexible handle is coupled to the interior surface of the vehicle window by a suction cup.

11. The method of claim 9, further comprising:
activating a strobe light coupled to the message panel or the support pole.

12. The method of claim 9, further comprising:
Replacing the message panel with a new message panel that display a new message.
